(19) United States
(12) Patent Application Publication
(10) Pub. No.: US 2026/0217443 A1
(43) Pub. Date: Jul. 30, 2026

(54) AN ASSEMBLY FOR DISPENSING POLYMERIC FOAM AND RELATED DISPENSING METHODS

(71) Applicant: SOUDAL N.V., Turnhout (BE)

(72) Inventors: Thomas DUIJSTERS, Turnhout (BE); Bart Jozef J. VERVOORT, Turnhout (BE); Joachim Marie Gerardus VERSTEGEN, Turnhout (BE); Ivan BOEYKENS, Turnhout (BE)

(73) Assignee: SOUDAL N.V., Turnhout (BE)

(21) Appl. No.: 19/148,354

(22) PCT Filed: Jan. 19, 2024
(86) PCT No.: PCT/EP2024/051212

§ 371 Date: Jul. 16, 2025

(30) Foreign Application Priority Data
Jan. 20, 2023 (BE) BE2023/5034

(51) Int. Cl. B65D 83/16; C08J 9/14; C08K 5/06; C08K 5/09

(52) U.S. Cl. CPC B65D 83/164; C08J 9/141; C08K 5/06; C08K 5/09; C08J 2375/04

(57) ABSTRACT

The present invention relates to an assembly for dispensing polymeric foam, the assembly comprising a pressurized can with foamable aqueous polymer composition and one or more propellants, and a dispensing gun, wherein the viscosity of the foamable aqueous polymer composition and the flow resistance of the dispensing gun are optimized to achieve high dispensing yield. The invention further relates to methods of dispensing a polymeric foam using a dispensing gun and to associated uses of a dispensing gun.

### FIELD OF THE INVENTION

The present invention relates to an assembly for dispensing polymeric foam, the assembly comprising a pressurized can with foamable aqueous polymer composition and one or more propellants, and a dispensing gun. The invention further relates to methods of dispensing a polymeric foam using a dispensing gun and to associated uses of a dispensing gun.

### BACKGROUND ART

Polymeric foams are well known products used in various applications, in particular in the building and construction industry. For example, polymeric foams are commonly used as insulation, caulking or sealant.

Traditional sprayable foams are most commonly polyurethane foams. The polyurethane is typically either produced in-situ during application of the product by reaction of a polyol component with a diisocyanate component (so-called two-component systems) or provided as a prepolymer with reactive isocyanate groups which is capable of moisture-curing (so-called one-component systems). Such products inevitably contain free (reactive) diisocyanates and are under investigation in different countries as they may have negative health effects on the user.

Foamable aqueous polymer compositions have been developed which are substantially free of reactive groups such as diisocyanates. For example, U.S. Pat. No. 7,029,609B2 discloses foamable polymer compositions comprising ionic foam stabilizers. U.S. Pat. No. 7,179,845B2 discloses various foamable polymer compositions comprising a fatty alcohol micelle forming agent.

A major challenge impeding widespread adoption of such foamable aqueous polymer compositions resides in the difficulties encountered when translating such products from a lab setting to a commercial setting, where the products are normally provided in the form of pressurized cans. The present inventors have found that the same formulation dispensed in a different way may give rise to a completely different foam when considering properties such as dimensional stability, elasticity, post-expansion (foam expansion in the timeframe just after application), dispensing yield (can rest fraction as well as joint filling performance), etc.

It is an object of the present invention to provide an assembly for dispensing a polymeric foam and associated dispensing methods which allow foamable aqueous polymer compositions to be dispensed resulting in improved foam properties such as dimensional stability, elasticity, post-expansion and/or dispensing yield (e.g. measured according to the experimental methods referred herein elsewhere) compared to known assemblies and methods.

### SUMMARY OF THE INVENTION

The present inventors have found that dispensing foamable aqueous polymer compositions from cans using a dispensing gun can be significantly improved by selecting (i) aqueous polymer compositions tuned to specific viscosities, (ii) specific can pressures, and (iii) specific baskets for fluidly connecting the can to the dispensing gun having a low flow resistance. The flow resistance of such baskets can for example be determined by determining the residual can pressure after keeping the dispensing gun trigger in completely opened position until no more product was dispensed. The residual can pressure is determined by the spring properties for baskets employing a spring-loaded check valve. As will be shown in the appended examples, selecting low flow resistance baskets results in foams having excellent dimensional stability, elasticity, insulation properties, adhesion, and airtightness, while exhibiting a large amount of post-expansion, no crumbling at lower temperatures (e.g. 5° C.) and achieving high dispensing yield. It was in particular observed that the assemblies of the present invention allow an excellent dispensing yield to be achieved which is both reflected by a low amount of product being retained in the can (and thus lost, reflecting waste) as well as the amount of joints of predetermined size which can be filled with the dispensed product (reflecting yield for the user).

Hence, in a first aspect the present invention provides an assembly for dispensing a polymeric foam comprising
a pressurized can comprising a foamable aqueous polymer composition and one or more propellants; and
a dispensing gun comprising a basket for fluidly connecting the can to the dispensing gun, said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked;
   wherein the foamable aqueous polymer composition has a dynamic viscosity determined according to the viscosity protocol at 20° C. and a 100 s⁻¹ shear rate of less than 1.5 Pa·s,
   wherein the can has an internal relative pressure at 20° C. of at least 100 kPa (1 bar), and
   wherein the blocking means comprised in the basket in the open position from the pressurized can until an internal relative pressure at 20° C. of less than 120 kPa (1.2 bar).

Preferably, the blocking means is a spring-loaded check valve comprising a spring having a spring constant of less than 1 N/mm.

In a further aspect, the invention provides a method of dispensing a polymeric foam comprising the steps of:
(i) providing a pressurized can comprising a foamable aqueous polymer composition and one or more propellants as described herein;
(ii) providing a dispensing gun as described herein;
(iii) mounting the pressurized can on the dispensing gun by fluidly connecting the can to the dispensing gun; and
(iv) dispensing the polymer composition from the can, thereby obtaining the polymeric foam.

In a further aspect, the invention provides the polymeric foam obtainable by the method described herein.

In a further aspect, the invention provides the use of a dispensing gun comprising a basket for fluidly connecting the can to the dispensing gun, said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked, wherein the blocking means in the open position permits flow from the pressurized can until an internal relative pressure at 20° C. of less than 120 kPa (1.2 bar)
for dispensing a polymeric foam from a pressurized can comprising a foamable aqueous polymer composition and one or more propellants
wherein the foamable aqueous polymer composition has a dynamic viscosity determined according to the viscosity protocol at 20° C. and a 100 s⁻¹ shear rate of less than 1.5 Pa·s, and
wherein the can has an internal relative pressure at 20° C. of at least 100 kPa (1 bar).

### BRIEF DESCRIPTION OF THE DRAWINGS

FIG. 1 shows a prior art dispensing gun comprising a basket for fluidly connecting the can to the dispensing gun, said basket comprising a spring-loaded check valve.

### DESCRIPTION OF EMBODIMENTS

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound, unless explicitly defined otherwise.

If a compound is referred to without any stereochemical designation (such as (cis), (trans), (E), (Z)), any stereoisomer of the compound is included.

Reference is made to substances, components, or ingredients in existence at the time just before first contacted, blended, or mixed with one or more other substances, components, or ingredients in accordance with the present disclosure. A substance, component or ingredient may gain an identity, property, or character through a chemical reaction or transformation during the course of contacting, blending, or mixing if conducted in accordance with this disclosure with the application of common sense and the ordinary skills of an average chemist. Unless otherwise indicated herein, definitions of substances, components, or ingredients and their relative amounts concern the composition as it is prepared at the time of first contacting the ingredients, unless expressly indicated otherwise. For example, it is well known to the skilled person that contacting a hydroxy-terminated polymer with a silane crosslinker as described herein may result in end-capping of the polymer. End-capping is typically performed on purpose by blending the polymer with the crosslinker and optionally a catalyst before addition of the remaining ingredients. Any time the present disclosure references a composition or the preparation of a composition comprising a polymer, a crosslinker and optionally further ingredients, unless indicated otherwise this expressly includes compositions wherein the polymer has been (end)-capped with a crosslinker or with the crosslinker referenced in the composition. The skilled person understands that for some polymers (e.g. styrene-acrylates), depending on the polymerization method employed, functional groups capable of reacting with a cross-linker can occur randomly over the polymer-chain, such that the term end-capping should not be understood as strictly referencing reaction at the “end” of the polymer chain.

As used herein, the expression “wt. %” when used in the context of an ionic compound (such as an ionic surfactant) refers to the amount of the compound inclusive of its counterion(s).

The film-forming temperature referred to herein is determined in accordance with ASTM D2354-10 (2018).

The dynamic viscosity referred to herein concerns the dynamic viscosity of the aqueous polymer composition before addition of propellants and is determined using the following method (referred to hereinafter as “the viscosity protocol”):
the method of DIN EN ISO 3219 (2021) is applied employing a HR-2 Discovery Hybrid Rheometer (TA Instruments);
the method of annex B of DIN EN ISO 3219 (2021) is applied wherein an upper rotatable stainless steel 25 mm plate in combination with a fixed lower Peltier plate is used instead of a cone plate;
the gap between the plates is 100 micron; and
the viscosity reported is the average value of viscosity measured between 15 and 60 seconds from the start of a peak hold test performed with the following settings: temperature 20° C., soak time 30 s, duration 60 s, shear rate 100 s⁻¹, sampling interval 1.0 s/pt.

The spring constant referred to herein is preferably determined using a Zwick Z010 tensile test bench using a 200N load cell.

In a first aspect the present invention provides an assembly for dispensing a polymeric foam comprising
a pressurized can comprising a foamable aqueous polymer composition and one or more propellants; and
a dispensing gun comprising a basket for fluidly connecting the can to the dispensing gun, said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked;
   wherein the foamable aqueous polymer composition has a dynamic viscosity determined according to the viscosity protocol at 20° C. and a 100 s⁻¹ shear rate of less than 1.5 Pa·s,
   wherein the can has an internal relative pressure at 20° C. of at least 100 kPa (1 bar), and
   wherein the blocking means comprised in the basket in the open position permits flow from the pressurized can until an internal relative pressure at 20° C. of less than 120 kPa (1.2 bar).

It is within the routine capabilities of the skilled person to adapt the viscosity of the aqueous polymer composition in order to fulfill the viscosity features of the present invention. The viscosity can for example be adapted by (a) adapting the amount of polymer in the aqueous polymer composition, (b) adding or adapting the amount of a rheology modifier in the aqueous polymer composition, (c) adding or adapting the amount of fillers in the aqueous polymer composition, (d) adapting the pH of the aqueous polymer composition, and/or € adapting the particle size of the polymer and/or filler in the aqueous polymer composition.

The foamable aqueous polymer composition is typically an aqueous polymer dispersion.

The foamable aqueous polymer composition preferably has a dynamic viscosity determined according to the viscosity protocol at 20° C. and a 100 s⁻¹ shear rate of less than 1.2 Pa·s, preferably less than 0.9 Pa·s. In particular, for optimal foam properties and yield (both considering can yield and joint yield), it is preferred that the foamable aqueous polymer composition preferably has a dynamic viscosity determined according to the viscosity protocol at 20° C. and a 100 s⁻¹ shear rate of less than 0.7 Pa·s, preferably less than 0.6 Pa·s, most preferably less than 0.5 Pa·s. In some particularly preferred embodiments the foamable aqueous polymer composition has a dynamic viscosity determined according to the viscosity protocol at 20° C. and a 100 s⁻¹ shear rate of less than 0.4 Pa·s or less than 0.280 Pa·s. In all of the embodiments described herein, it is preferred that the foamable aqueous polymer composition preferably has a dynamic viscosity determined according to the viscosity protocol at 20° C. and a 100 s⁻¹ shear rate of at least than 0.05 Pa·s, preferably at least 0.1 Pa·s.

Typically the can will have an internal relative pressure at 50° C. of less than 1200 kPa (12 bar). The can preferably has an internal relative pressure at 20° C. of at least 200 kPa (2 bar), more preferably at least 300 kPa (3 bar), most preferably at least 400 kPa (4 bar). The can preferably has an internal relative pressure at 20° C. within the range of 100-1000 kPa (1-10 bar), preferably within the range of 300-700 kPa (3-7 bar), more preferably within the range of 400-600 kPa (4-6 bar), in particular 450-550 kPa (4.5-5.5 bar).

According to the invention, the can comprises a valve (typically called an aerosol valve) which is configured to open upon connecting the can to the dispensing gun.

The flow resistance of the basket for fluidly connecting the can to the dispensing gun will typically be determined by the blocking means, which is typically placed inside the flow channel. Even in an open position the blocking means (e.g. a spring-loaded check valve) is typically still present in the flow channel, the product flowing between the blocking means and the walls of the flow channel such that the blocking means is the determining factor for the overall flow resistance of the basket. In preferred embodiments of the invention the values provided herein for the flow resistance of the blocking means, in particular the internal can pressures at which the blocking means permits flow, are also provided as preferred embodiments for the flow resistance of the basket as a whole.

The flow resistance of the blocking means comprised in the basket in the open position according to the invention is such that the blocking means permits flow from the pressurized can until an internal relative pressure at 20° C. of less than 120 kPa (1.2 bar). In preferred embodiments the flow resistance is determined by connecting the pressurized can to the dispensing gun, and keeping the trigger in completely opened position until no more product is dispensed, followed by determining the residual internal relative pressure at 20° C. of the can after dispensing. The flow resistance according to the invention is measured with the blocking means in the open position. As the skilled person will understand, in case a spring-loaded check valve is used, it automatically moves from the closed to the open position depending on the pressure of the can connected to the basket, and the flow resistance is the point at which the internal pressure of the can cannot overcome the force exerted by the spring such that the flow channel is closed.

In preferred embodiments of the invention, the blocking means comprised in the basket in the open position permits flow from the pressurized can until an internal relative pressure at 20° C. of less than 100 kPa (1 bar), preferably less than 80 kPa (0.8 bar). As is shown in the appended examples, it was found that flow resistances allowing dispensing until can pressures as low as 50 kPa (0.5 bar) can be achieved. Hence, in some embodiments of the invention the blocking means comprised in the basket in the open position permits flow from the pressurized can until an internal relative pressure at 20° C. within the range of 50-120 kPa (0.5-1.2 bar), preferably within the range of 50-100 kPa (0.5-1 bar), more preferably within the range of 50-80 kPa (0.5-0.8 bar).

A highly preferred embodiment of a blocking means suitable for use in the baskets described herein is a spring-loaded check valve. Dispensing guns comprising a basket with a spring-loaded check valve are known to the skilled person. A check valve is also called a backflow-prevention valve, a non-return valve, or a one-way valve. The spring-loaded check valve is preferably a ball-spring check valve. The ball-spring check valve functions such that upon connection of the can to the gun, the pressure provided by the can exerts a force on the ball causing the spring to compress, thereby opening a fluid passageway from the can to the dispensing gun. As the can empties and pressure drops, the spring expands and eventually closes the gun barrel such that clean coupling and decoupling of the can is enabled. Hence, it will be understood by the skilled person that the spring of the spring-loaded check valve is provided for controlling movement of the valve closing means (e.g. the ball of the ball-spring check valve). The spring-loaded check valve as referred to in the different aspects of the invention described herein has a spring constant of less than 1 N/mm, preferably less than 0.4 N/mm, more preferably less than 0.1 N/mm. For example, in some embodiments of the different aspects of the invention described herein, the spring constant is less than 0.08 N/mm, less than 0.06 N/mm or less than 0.05 N/mm.

The spring-loaded check valve may comprise a second spring having a spring constant of more than 1.5 N/mm, preferably more than 2.5 N/mm, more preferably more than 3.2 N/mm and which is placed coaxially to the first spring having a spring constant of less than 1 N/mm, preferably less than 0.4 N/mm, more preferably less than 0.1 N/mm, wherein the first spring coaxially extends beyond the second spring in at least one direction such that movement of the valve closing means (e.g. the ball of the ball-spring check valve) upon connection of a can to the basket is first independently controlled by the first spring, but wherein valve closing means encounters the second spring before the first spring is completely collapsed. This avoids complete closure of the passage to the dispensing gun in case of high can pressures, for example when coupling a new, full can.

A preferred embodiment of an alternative blocking means suitable for use in the baskets described herein is as described in CN113798081A, incorporated herein by reference. In particular, the basket as described in FIG. 2 and paragraphs [0030]-[0041] of CN113798081A are incorporated herein by reference. Generally stated, in a preferred embodiment of the invention, the basket comprises an elongated flow channel connecting the can to the dispensing gun and is equipped with a blocking means which comprises a pin-like structure placed inside the flow channel which is configured to be axially moveable in the flow channel between an open position wherein flow from the can to the dispensing gun is enabled and a closed position wherein flow from the can to the dispensing gun through the flow channel is blocked, the position of said pin-like structure inside the flow channel preferably being controlled by rotational movement, such as rotation of part or whole of the basket.

The dispensing gun in all embodiments of the present invention typically further comprises a handle for holding the gun, a dispensing tube with a dosing nozzle, means for opening and closing the dosing nozzle, and a trigger for actuating said means in order to open the dosing nozzle and to dispense the polymeric foam from a dispensing opening at an end of the dispensing tube. The means for opening and closing the dosing nozzle typically comprises a spring-loaded needle which is co-axially moveable in the dispensing tube, and optionally further comprises regulating means for regulating the degree of opening of the outlet of the dosing nozzle, such as a back-screw. It will be understood by the skilled person that in order to dispense the polymeric foam, upon opening the dozing nozzle a fluid pathway is opened reaching from the can through the basket via the dosing nozzle and into the dispensing tube which opens up to the environment.

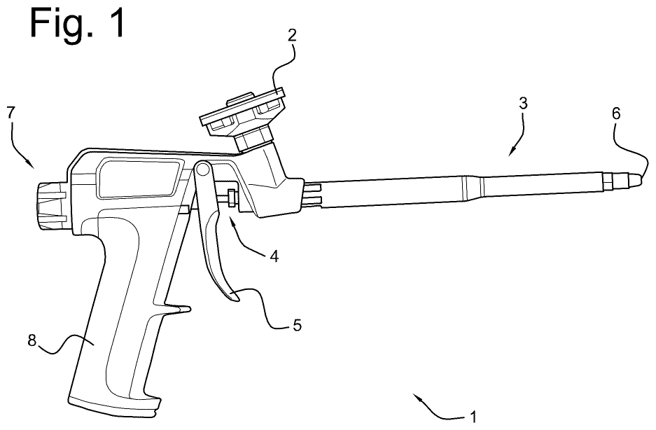

FIG. 1 shows an example of a prior art dispensing gun (1) comprising a basket (2) for fluidly connecting the can to the dispensing gun, said basket (2) comprising a spring-loaded check valve (not shown). The gun further comprises a dispensing tube (3) with a dosing nozzle (not shown) placed in the dispensing tube (3) of the gun, a spring-loaded needle (4) which is co-axially moveable in the dispensing tube for opening and closing the dosing nozzle, and a trigger (5) for actuating said spring-loaded needle (4) in order to open the dosing nozzle and to dispense the polymeric foam through the dispensing opening (6). The gun further comprises a back-screw (7) for regulating the degree of opening of the outlet of the dosing nozzle and a handle (8) for holding the gun.

In some embodiments of the invention, the dispensing gun further comprises a spray adapter, which is detachably mountable on the dispensing opening of the dispensing tube and which is suitable for adapting the spray pattern of the polymeric foam from the dispensing tube. In particularly preferred embodiments, the spray adapter is suitable for broadening the spray pattern of the polymeric foam from the dispensing tube. As a consequence large surfaces (e.g. walls) can more easily be insulated. Such spray adapters suitable for broadening the spray pattern of the polymeric foam are known to the skilled person and typically comprise an adapter dispensing opening which is oval shaped, and may provide further means to influence the spray pattern such as one or more walls extending next to the spray opening. The present inventors have found that the assembly of the invention is particularly useful to prevent sputtering when a broadening spray adapter is used.

In view of the fact that isocyanate groups react with water, the foamable aqueous polymer composition is substantially free of isocyanate groups.

The foamable aqueous polymer composition preferably comprises less than 5 wt. % (by total weight of the foamable aqueous polymer composition), preferably less than 1 wt. %, more preferably less than 0.1 wt. % of a monomer. The monomer is preferably a monomer of the type which is included in polymerized form in the polymer. Hence, the foamable aqueous polymer composition preferably comprises less than 5 wt. % (by total weight of the foamable aqueous polymer composition), preferably less than 1 wt. %, more preferably less than 0.1 wt. % of a monomer of the type which is included in polymerized form in the polymer. For example, if the polymer comprises polystyrene, then the foamable aqueous polymer composition preferably comprises less than 5 wt. % (by total weight of the foamable aqueous polymer composition) of styrene monomer. In particularly preferred embodiments, the monomer described herein is present in an the foamable aqueous polymer composition in an amount of less than 0.05 wt. % (by total weight of the foamable aqueous polymer composition), preferably less than 0.01 wt. %.

The ratio (w/w) of the foamable aqueous polymer composition to the one or more propellants is typically within the range of 70:30 to 99.5:0.5, preferably within the range of 80:20 to 99.5:0.5, more preferably within the range of 90:10 to 99.5:0.5, such as 92:8 to 99.5:0.5. For example, the ratio (w/w) of the foamable aqueous polymer composition to the one or more propellants may be within the range of 70:30 to 99.2:0.8, preferably within the range of 80:20 to 99.2:0.0.8, more preferably within the range of 90:10 to 99.2:0.8, such as 92:8 to 99:1. In case propellants are included in the can in liquid form (typically liquefied due to the high can pressure), for the purposes of the present invention (in particular for determining the ratio (w/w) of the foamable aqueous polymer composition to the one or more propellants), such liquid propellants are not considered as part of the foamable aqueous polymer composition but are considered as part of the propellants. In some embodiments of the invention the ratio (w/w) of the foamable aqueous polymer composition to the one or more propellants is within the range of 80:20 to 98:2, preferably within the range of 90:10 to 98:3, more preferably within the range of 92:8 to 97:4. In other embodiments of the invention the ratio (w/w) of the foamable aqueous polymer composition to the one or more propellants is within the range of 90:10 to 99.5:0.5, preferably within the range of 95:5 to 99.2:0.8, more preferably within the range of 97:3 to 99.2:0.8, such as within the range of 97.5:2.5 to 99:1. In these latter embodiments, the present inventors have found that the hardness and dimensional stability is even further improved.

As will be understood by the skilled person from the above embodiments, in preferred embodiments of the invention
the foamable aqueous polymer composition has a dynamic viscosity determined according to the viscosity protocol at 20° C. and a 100 s⁻¹ shear rate within the range of 0.05 to 1.2 Pa·s, preferably within the range of 0.1 to 0.9 Pa·s; and
the ratio (w/w) of the foamable aqueous polymer composition to the one or more propellants is within the range of 70:30 to 99.5:0.5, preferably within the range of 80:20 to 99.5:0.5, more preferably within the range of 90:10 to 99.5:0.5, such as 92:8 to 99.5:0.5.

In some embodiments of the invention
the foamable aqueous polymer composition has a dynamic viscosity determined according to the viscosity protocol at 20° C. and a 100 s⁻¹ shear rate within the range of 0.05 to 1.2 Pa·s, preferably within the range of 0.1 to 0.9 Pa·s; and
the ratio (w/w) of the foamable aqueous polymer composition to the one or more propellants is within the range of 95:5 to 99.2:0.8, more preferably within the range of 97:3 to 99.2:0.8, such as within the range of 97.5:2.5 to 99:1,
preferably
the foamable aqueous polymer composition has a dynamic viscosity determined according to the viscosity protocol at 20° C. and a 100 s⁻¹ shear rate within the range of 0.1 to 1 Pa·s, preferably within the range of 0.1 to 0.75 Pas, most preferably within the range of 0.2 to 0.55 Pa·s; and
the ratio (w/w) of the foamable aqueous polymer composition to the one or more propellants is within the range of 95:5 to 99.2:0.8, more preferably within the range of 97:3 to 99.2:0.8, such as within the range of 97.5:2.5 to 99:1.

In order to be relevant for common applications, the foamable aqueous polymer composition preferably has a minimum film forming temperature of less than 25° C.

The foamable aqueous polymer composition preferably comprises at least 20 wt. % of polymer (by total weight of the aqueous polymer composition), preferably at least 30 wt. % of polymer, most preferably at least 40 wt. % of polymer. The foamable aqueous polymer composition preferably comprises at most 80 wt. % of polymer (by total weight of the aqueous polymer composition), preferably at most 70 wt. % of polymer, most preferably at least 65 wt. %. The present inventors have found that such polymer compositions are suitable in the context of the present invention to obtain the excellent foam properties as well as yield (both can yield and joint yield) described herein earlier. In case low polymer contents are used, it is preferred to include other materials (such as fillers) such that the aqueous polymer composition has a sufficiently high solids content in order to facilitate drying/film forming after application. Hence, in all embodiments of the invention described herein, the foamable aqueous polymer composition preferably has a solids content of at least 30 wt. % (by total weight of the foamable aqueous polymer composition), preferably at least 40 wt. %, more preferably at least 45 wt. %. The solids content as referred to herein concerns the solids content as determined by a gravimetry wherein 1-2 g of the dispersion is weighed, subsequently dried at 120° C. in a circulating air oven until constant mass is reached, and the resulting residue is weighed again in order to calculate the total solids content. The water content is preferably at most 70 wt. % (by total weight of the aqueous polymer composition), preferably at most 60 wt. %, more preferably at most 55 wt. %. The water content is preferably at least 25 wt. %, more preferably at least 35 wt. %, most preferably at least 40 wt. %. The water content can suitable be determined using Karl-Fischer titration.

The foamable aqueous polymer composition preferably comprises a polymer selected from the group consisting of polyurethanes, polyacrylates, polyurethane acrylate copolymers, polyalkyl acrylates, polystyrenes, styrene acrylate copolymers, polyisocyanurates, polyvinylacetates, vinyl acetate alkylene copolymers, styrene alkylidene copolymers, copolymers thereof and combinations thereof. It is highly preferred that the foamable aqueous polymer composition comprises a polymer selected from the group consisting of polyurethanes, polyacrylates, polyurethane acrylate copolymers, copolymers thereof, and combinations thereof, most preferably a polyurethane or a copolymer thereof. As will be understood by the skilled person, the polymer backbone and/or side chains may have been be further chemically functionalized or derivatized, for example by crosslinking agents or by anchoring of functional molecules such as antimicrobials.

In some embodiments the polyurethane comprises carboxylic acid groups in the form of free acid and/or carboxylate. Such polyurethanes are obtainable by including a portion of carboxylic acid containing monomer during polymerisation (typically a diol further comprising a carboxylic acid functionality such as dimethylol propionic acid) and optionally converting the carboxylic acid groups to carboxylates with an amine such as triethylamine. The resulting salt has good water solubility. Similarly, incorporation of sulfonic acid or sulfonate functionality, or phosphoric acid or phosphonate functionality can also be used. For example, mono- and dihydroxy carboxylic acids or carboxylates, mono- and dihydroxy sulfonic acids or sulfonates, or mono- and dihydroxy phosphonic acids or phosphonates may be suitable. Alternatively, mono- and diaminocarboxylic acids or carboxylates, mono- and diaminosulfonic acids or sulfonates, or mono- and diaminophosphonic acids or phosphonates may also be suitable.

Hence, the foamable aqueous polymer composition preferably comprises 20-80 wt. % (by total weight of the aqueous polymer composition) of a polymer selected from the group consisting of polyurethanes, polyacrylates, polyurethane acrylate copolymers, polyalkyl acrylates, polystyrenes, styrene acrylate copolymers, polyisocyanurates, polyvinylacetates, vinyl acetate alkylene copolymers, styrene alkylidene copolymers, copolymers thereof and combinations thereof, more preferably 30-70 wt. %, most preferably 40-65 wt. %. The polymer is preferably selected from the group consisting of polyurethanes, polyacrylates, polyurethane acrylate copolymers, copolymers thereof, and combinations thereof, most preferably a polyurethane or a copolymer thereof.

The one or more propellants comprised in the pressurized can may be any suitable propellant known in the art. The one or more propellants are preferably selected from the group consisting of C₁-C₄ saturated or unsaturated hydrocarbons (e.g. n-pentane, n-butane, isobutane, n-hexane, 2-methylbutane, propane, 1-pentene, butene, 2-methyl-2-butene, cyclobutane, cyclopentane, cyclohexane), vinyl chloride, methyl chloride, chlorofluorocarbons, hydrochlorofluorocarbons, hydrohaloolefins, air, carbon dioxide, argon, nitrogen, nitrous oxide, dimethyl ether, diethyl ether, dimethoxymethane, methyl formate, and combinations thereof. Preferably, the one or more propellants are selected from the group consisting of 1,3,3,3-tetrafluoropropene (HFO 1234ze); 2,3,3,3-tetrafluoroprop-1-ene (HFO 1234yf); 1,1,3,3-tetrafluoropropene; 1,2,3,3,3-pentafluoropropene (HFO 1225ye); 3,3,3-trifluoropropene; 1,1,3,3,3-pentafluoropropene (HFO 1225zc); 1,1,2,3,3-pentafluoropropene (HFO 1225yc); (Z)-1,1,1,2,3-pentafluoropropene (HFO 1225yez); trans-1,1,1,4,4,4-hexafluoro-2-butene (HFO 1336mzz (E)), 1,1,1,4,4,4-Hexafluoro-2-butene (HFO-1336mzz), 1-chloro-3,3,3,-trifluoropropene (HFO-1233zd), n-butane, isobutane, propane, dimethylether and combinations thereof. More preferably, the one or more propellants are selected from the group consisting of 1,3,3,3-tetrafluoropropene (HFO 1234ze), n-butane, isobutane, propane, dimethylether and combinations thereof. In all the embodiments described herein, the 1,3,3,3-tetrafluoropropene (HFO 1234ze) is preferably HFO 1234ze (E).

The present inventors have found that improved foam properties such as dimensional stability, elasticity, post-expansion and/or yield (can yield and joint yield) are achieved when a combination of butane (as isobutane and/or n-butane) and propane is used as propellant. Hence, the propellant comprised in the pressurized can described herein preferably comprises or consists of the combination of isobutane and propane. In such embodiments, the ratio (w:w) of butane (as isobutane and/or n-butane) to propane is preferably within the range of 5:1 to 1:1, preferably within the range of 3:1 to 1.8:1.

The foamable aqueous polymer composition may further comprise one or more additives selected from the group consisting of film forming agents, dispersing agents, pH adjusters, fillers, fire retardants, surfactants, thickeners, crosslinkers, adhesion promotors, biocides (e.g. fungicides or algicides), colorants, etc. The total amount of additives (calculated as the total amount of components excluding water and any polymers) is typically less than 40 wt. %, (by total weight of the foamable aqueous polymer composition), such as less than 30 w. %, less than 25 wt. % or even less than 15 wt. %.

Any film forming agent known in the art may be used in the foamable aqueous polymer composition described herein. Examples of suitable film forming agents are polyvinylpyrrolidone (PVP), texanol, propylene glycol, di(propylene glycol) methyl ether, and dicarboxylic acid-diisobutyl ester.

Any dispersing agent known in the art may be used in the foamable aqueous polymer composition described herein. An example of a suitable dispersing agent is a carboxylated polyacrylate.

Any pH adjuster known in the art may be used in the foamable aqueous polymer composition described herein. Examples of suitable pH adjusters are ammonia, alkylamines, strong acids and strong bases.

Any filler known in the art may be used in the foamable aqueous polymer composition described herein. Examples of suitable fillers mineral fillers, metal oxide fillers, fly ash, bottom ash, carbon black, glass and combinations thereof. For example, aluminum silicate, aluminum hydroxide, fumed silica calcium silicate, magnesium silicate, dolomite, calcium carbonate, barium sulfate, calcium sulfate, glass fibers, hollow glass microspheres, carbon black, chalk, titanium dioxide, zinc oxide, siloxanes and/or silica. The filler may be surface modified. Surface modification of fillers is known to the skilled person. Preferred surface modifications include surface treatment with a fatty acid (e.g. stearic acid) or a silane (e.g. an alkoxysilane).

Any fire retardant known in the art may be used in the foamable aqueous polymer composition described herein. Examples of suitable fire retardants are tris(2-chloroethyl)phosphate, tris(2-chloropropyl)phosphate, tris(1-chloro-2-propyl)phosphate, tris(2,3-dibromopropyl)phosphate, tris(1,3-dichloropropyl)phosphate, tri(2-chloroisopropyl)phosphate, tricresyl phosphate, tri(2,2-dichloroisopropyl)phosphate, diethyl N, N-bis(2-hydroxyethyl)aminomethylphosphonate, dimethyl methylphosphonate, tri(2,3-dibromopropyl)phosphate, tri(1,3-dichloropropyl)phosphate, tetrakis-(2-chloroethyl)ethylenediphosphate, triethylphosphate, diammonium phosphate, antimony oxide, aluminum trihydrate, polyvinyl chloride, melamine, tribromoneopentylalcohol, tris(1-chloro-2-propyl) phosphate, triethylphosphate, ammonium polyphosphate, aluminum hydroxide, boric salts and combinations thereof.

Any surfactant known in the art may be used in the foamable aqueous polymer composition described herein, including anionic, cationic, non-ionic and zwitterionic surfactants. Surfactants may for example function as emulsifier, wetting agent, foaming agent. Examples of suitable non-ionic surfactants include ethoxylated alkylphenols (e.g. ethoxylated octylphenol (TRITON® X series) or ethoxylated nonylphenol (TERGITOL®NP series)), glycol distearate, glycol stearate, lanolin esters, lanolin alcohols, ethoxylated fatty alcohols (TERGITOL™TMN and 15-S series), fatty alcohols, polysorbates, polyoxyalkylene ethers, and silicone surfactants (e.g. polysiloxane polyoxyalkylene block co-polymers, Hydropalat® WE series). Examples of suitable anionic surfactants include anionic sulfates, carboxylates (e.g. ammonium stearate, potassium oleate), sulfonates (e.g. sodium lauryl sulfate), sacrosinates, phosphates, phosphonates, sulfated fatty alcohol ethoxylates (e.g. Disponil® FES-32 from Cognis Corp.), dodecylbenzene sulfonates (e.g. Rhodacal® DS-4 from Rhodia Corp.), sodium dioctyl sulfosuccinate (e.g. Aerosol® OT-70 from Cytec Industries, mono alkylene sulfosuccinamate, fatty alcohol polyglycol ether sulphates and ammonium salts of alkyl ethoxylate phosphate (e.g. Rhodacal® RS-610 from Rhodia Corp.). Examples of suitable cationic surfactants include benzalkonium salts, alkyl trimethyl ammonium salts (e.g. Empigen® CM), alkyl dimethyl benzyl ammonium salts (e.g. Empigen® BAC 50, Servamine® KAC 422 D, Ninox® 4002). Examples of suitable zwitterionic surfactants include phospholipids (e.g. lecithin), fatty acid amphoacetates and betaines. Preferably the surfactant is selected from the group consisting of anionic surfactants, non-ionic surfactants, and combinations thereof. More preferably the surfactant is a silicone surfactant, such as a polysiloxane polyoxyalkylene block co-polymer or a stearate, such as ammonium stearate. In embodiments the surfactant is a silicone surfactant is selected from the group consisting of Momentive's L-5130, L-5180, L-5340, L-5440, L-6100, L-6900, L-6980 and L-6988; Air Products DC-193, DC-197, DC-5582, and DC-5598; and B-8404, B-8407, B-8409 and B-8462 from Goldschmidt AG of Essen, Germany. Others are disclosed in U.S. Pat. Nos. 2,834,748; 2,917,480; 2,846, 458 and 4,147,847. In embodiments the surfactant is a stearate, preferably ammonium stearate.

Any thickener known in the art may be used in the foamable aqueous polymer composition described herein. Examples of suitable thickeners are polyurethane thickeners (e.g. Rheovis 1190, Tafigel® PUR 40, Tafigel® PUR 55), fumed silica (e.g. Aerosil R974), cellulose derivates (e.g. Methocel® 228, Methocel® A, Methocel® 311), acrylate thickeners (e.g. Rheovis HS1169, A P1/1, Mirox AM), bentonite, hectorite, montmorillonite, silicic acids (e.g. Aerosil® 200).

Any crosslinker known in the art may be used in the foamable aqueous polymer composition described herein. The appropriate crosslinker will naturally depend on the polymer used. Organosilanes are useful crosslinkers (e.g. Coatosil MP200) as well as ammonium zirconium compounds, such as Halox XTAIN L-44. Examples of preferred organosilane crosslinkers silanes according to formula (I) and hydrolysis or condensation products thereof:

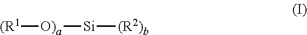

wherein
a is 3 or 4;
b is 1 or 0;
a+b is 4;
wherein each occurrence of R¹ is individually selected from the group consisting of hydrogen, C₁-C₈ alkyl, C₁-C₈ haloalkyl, C₁-C₈ aminoalkyl, C₂-C₈ alkenyl, C₃-C₈ cycloalkyl, C₄-C₈ cycloalkenyl, C₆-C₁₀ aryl, —C(O)R³, —N═CR⁴R⁵ and —N═CR⁶;
R³, R⁴ and R⁵ are selected from the group consisting of C₁-C₄ alkyl;
R⁶ is a bivalent C₂-C₈ alkyl radical such that —N═CR⁶ is a cycloalkyl; and
R² is selected from the group consisting of hydrogen and optionally substituted monovalent hydrocarbon radicals having from 1 to 30 carbon atoms.

Any adhesion promotor known in the art may be used in the foamable aqueous polymer composition described herein. Examples of suitable adhesion promotors are organosilane adhesion promotors selected from the group consisting of aminosilanes, alkoxysilanes and epoxysilanes, preferably selected from the group consisting of aminoalkyltrialkoxysilanes, aminoalkylalkyldialkoxysilanes, bis(alkyltrialkoxysilyl)amines, tris(alkyltrialkoxysilyl)amines, tris(alkyltrialkoxysilyl)cyanuarates, tris(alkyl-trialkoxy-silyl)isocyanuarates, alkoxy terminated polydimethylsiloxanes comprising aminoalkyl sidegroups (such as ethoxy terminated (3-aminopropyl)(methyl) polysiloxane)), hydroxy-terminated polydimethylsiloxane end-capped with N-(3-trimethoxysilyl) propyl cyclohexane amine, condensation products of any of the recited silanes, and combinations thereof. Preferably the alkyl group is a C₁-C₄ alkyl and the alkoxy group is a C₁-C₄ alkoxy. In embodiments of the invention the aqueous polymer compositions described herein are provided further comprising an adhesion promotor which is selected from the group consisting of 3-aminopropyl triethoxy silane, 3-aminopropyl trimethoxy silane, N-(2-aminoethyl)-3-aminopropyl trimethoxy silane, 3-(2-aminoethylamino) propyl triacetoxy silane, N-(3-trimethoxysilylpropyl) diethylene-triamine, b is-(3-methoxysilylpropyl)-amine, amino ethylaminopropyl methyl dimethoxy silane, N-(2-aminoethyl)-3-aminopropyl dimethoxy methyl silane, N-(n-butyl)-3-aminopropyl trimethoxy silane, N-(n-butyl)-3-aminopropyl trimethoxy silane, 3-aminopropyl methyl diethoxy silane, amino ethyl amino trimethoxy silane, 3-glycidoxypropyl trimethoxy silane, 3-glycidoxypropyl triethoxy silane, gamma-ureidopropyl trimethoxy-silane, 3-aminopropyl(methyl) silsesquioxanes, condensation products thereof and combinations thereof. Highly preferred adhesion promotors are epoxysilanes, such as 3-glycidoxypropyl trimethoxy silane or 3-glycidoxypropyl triethoxy silane, condensation products thereof and combinations thereof.

Any colorants known in the art may be used in the foamable aqueous polymer composition described herein. Examples of suitable colorants are titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines, preferably a reactive polymer with a chromophore.

It will be understood by the skilled person that a single additive may perform multiple functions, e.g. a silane can be used as crosslinker and adhesion promotor. In general it is preferred that the foamable aqueous polymer composition described herein comprises an additive selected from aminosilanes, epoxysilane, condensation products thereof and combinations thereof, such as 3-glycidoxypropyl trimethoxy silane or 3-glycidoxypropyl triethoxy silane, condensation products thereof and combinations thereof.

In another aspect the invention provides a method of dispensing a polymeric foam comprising the steps of:
(i) providing a pressurized can comprising a foamable aqueous polymer composition and one or more propellants as described herein;
(ii) providing a dispensing gun as described herein;
(iii) mounting the pressurized can on the dispensing gun by fluidly connecting the can to the dispensing gun; and
(iv) dispensing the polymer composition from the can, thereby obtaining the polymeric foam.

Step (iv) is preferably performed at an ambient temperature of at least 0° C., preferably at least 15° C. and preferably of at most 40° C., preferably at most 35° C. Step (iv) is preferably performed at an ambient relative humidity of less than 80%.

As will be shown in the appended examples, the inventors have found that the assembly of the present invention allows excellent foam properties to be achieved. Hence, the polymeric foam obtained in step (iv) is preferably a polyurethane foam having one or more of the following properties:
a post-expansion of at least 15% determined according to method EN 17333-2 (2020), preferably at least 25%;
a dimensional change smaller than 10% determined according to method EN 17333-2 (2020), preferably smaller than 5%;
a change in tensile strength of less than 10% after 1000 cycles of 10% compression and stretching according to method EN 17333-4 (2020), preferably a change in tensile strength of less than 5%; and/or
a thermal conductivity of less than 0.05 W/m*K determined according to DIN EN12667:2001, preferably less than 0.04 W/m*K.

The method of the present invention is extremely suitable for providing airtight sealing, which is normally challenging to achieve with aqueous polymer compositions. Hence, in embodiments the method described herein is a method for providing airtight sealing. The method of the present invention, in particular the method for providing airtight sealing, preferably comprises depositing the polymeric foam (a) around a door frame, such as an interior door frame of a building, or (b) between adjacent parts or layers of drywall.

In some embodiments of the method described herein, the dispensing gun further comprises a spray adapter as described herein earlier mounted on the gun, and the polymeric composition is dispensed through the spray adapter.

The assemblies and associated methods of the present invention allow very high yields (both can yield and joint yield) to be achieved, meaning very little residue is left in the can after completely dispensing the contents, leading to less waste while a large amount of joints of predetermined size can be filled, reflecting useful yield for the user. In preferred embodiments, the method described herein is provided wherein less than 15 wt. % residue is left in the can after maximally dispensing the polymer composition from the can, wherein 100 wt. % residue corresponds to the total amount of foamable aqueous polymer composition and propellants in the can before dispensing any polymer composition from the can. Preferably less than 12 wt. % residue is left in the can, more preferably less than 10 wt. % residue is left in the can. Maximally dispensing the polymer composition from the can means that normal operation of the dispensing gun does not liberate more product from the can. In practice this means that actuating the trigger on the dispensing gun no longer results in dispensing of can contents. A convenient way to determine the wt. % residue left is by filling a can of known weight with a known amount of aqueous polymer dispersion and propellants, connecting the can to a dispensing gun, actuating the trigger until no more product is released (thereby achieving maximal dispensing of the polymer composition from the can), weighing the depleted can, allowing the weight of residue left to be determined and thereby the wt. % of residue to be calculated (wherein 100 wt. % is the total amount of foamable aqueous polymer composition and propellants in the can before dispensing).

In another aspect the present invention provides a polymeric foam obtainable by the methods described herein.

In another aspect the present invention provides a polymeric foam obtainable from a foamable aqueous polymer composition which has one or more of the following properties:
a post-expansion of at least 15% determined according to method EN 17333-2 (2020), preferably at least 25%;
a dimensional change smaller than 10% determined according to method EN 17333-2 (2020), preferably smaller than 5%;
a change in tensile strength of less than 10% after 1000 cycles of 10% compression and stretching according to method EN 17333-4 (2020), preferably a change in tensile strength of less than 5%; and/or
a thermal conductivity of less than 0.05 W/m K determined according to DIN EN12667:2001, preferably less than 0.04 W/m*K.

In another aspect the present invention provides the use of a dispensing gun comprising a basket for fluidly connecting the can to the dispensing gun, said basket comprising a spring-loaded check valve, wherein the spring of the spring-loaded check valve has a spring constant of less than 1 N/mm said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked, wherein the blocking means in the open position permits flow from a can having an internal relative pressure at 20° C. of less than 120 kPa (1.2 bar),
for dispensing a polymeric foam from a pressurized can comprising a foamable aqueous polymer composition and one or more propellants
wherein the foamable aqueous polymer composition has a dynamic viscosity a dynamic viscosity determined according to the viscosity protocol at 20° C. and a 100 s⁻¹ shear rate of less than 1.5 Pa·s, and
wherein the can has an internal relative pressure at 20° C. of at least 100 kPa (1 bar).

The embodiments described herein earlier in relation to the dispensing gun, to the properties and composition of the aqueous polymer composition, as well as to the propellants are all equally applicable to the use of the present invention.

### EXAMPLES

Several polyurethane polymer compositions were prepared having different amounts of film forming agent. The compositions are shown in the below tables (amounts are in gram unless indicate otherwise).

The dynamic viscosity of the aqueous polymer composition before addition of propellants was determined according to the viscosity protocol.

The pressurized cans were connected to three different dispensing guns for testing. The wt. % residue left in the can after dispensing as much product as possible using the dispensing gun trigger was recorded (wherein 100 wt. % corresponds to the complete 490.5 g aqueous polymer composition+propellants loaded in the can before dispensing).

Gun A: a dispensing gun equipped with a basket having a ball-spring check valve having two coaxial springs: a first spring with a spring constant of 0.0407 N/mm and a second spring with a higher spring constant. The first spring is larger than the second spring such that it extends coaxially beyond the second spring. As a result, movement of the ball upon connection of a can to the basket is first independently controlled by the first spring, but the ball encounters the second spring before the first spring is completely collapsed. The flow resistance by the basket was determined by connecting the pressurized can of example 1 to the dispensing gun, and keeping the trigger in completely opened position until no more product was dispensed. The residual pressure in the can was then measured. The basket of gun A permits flow from the pressurized can until an internal relative pressure at 20° C. of about 70 kPa (0.7 bar) or more.

Gun B: a dispensing gun employing a basket as described in CN113798081A available from ZHEJIANG CHAOYU TOOLS CO LTD model PU FOAM no-clean single component extended PU foam gun CY-099T-S. The basket comprises an elongated flow channel connecting the can to the dispensing gun and is equipped with a blocking means which comprises a pin-like structure placed inside the flow channel which is configured to be moveable between an open position wherein flow from the can to the dispensing gun is enabled and a closed position wherein flow from the can to the dispensing gun through the flow channel is blocked, the position of said pin-like structure inside the flow channel being controlled by rotation of the basket. The flow resistance by the basket was determined by connecting the pressurized can of example 1 to the dispensing gun, and keeping the trigger in completely opened position until no more product was dispensed. The residual pressure in the can was then measured. The basket of gun B permits flow from the pressurized can having an internal relative pressure at 20° C. of about 50 kPa (0.5 bar) or more.

Gun C: As a comparative test, the pressurized cans were also connected to a dispensing gun equipped with a basket having a ball-spring check valve having a single spring with a spring constant of 3.72 N/mm. The flow resistance by the basket was determined by connecting the pressurized can of example 1 to the dispensing gun, and keeping the trigger in completely opened position until no more product was dispensed. The residual pressure in the can was then measured. The basket of gun C permits flow from the pressurized can having an internal relative pressure at 20° C. of about 170 kPa (1.7) bar or more.

The useful yield for the user was also tested by determining the number of joints of predetermined size which can be filled (wherein joints are completely filled immediately upon dispensing, i.e. before any significant post-expansion occurs). The can relative pressures of the formulations in the below table before dispensing were in the range of 400-600 kPa (4-6) bar at 20° C.

Aqueous polymer composition

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | Ex. 10 |
| | Aqueous | 89 | 87 | 85 | 95 | 94.9 | 94.8 | 94.7 | 94.6 | 94.2 | 93.8 |
| | polyurethane | | | | | | | | | | |
| | dispersion (~51 | | | | | | | | | | |
| | wt. % polyurethane) | | | | | | | | | | |
| [symbol] PL 5651 | Film forming agent | 4.5 | 6.5 | 8.5 | 0 | 0 | 0 | 0 | 0 | 0 | 0 |
| Ammonium-stearate | Surfactant - Foam | 6.5 | 6.5 | 6.5 | 5 | 5 | 5 | 5 | 5 | 5 | 5 |
| | stabilizer | | | | | | | | | | |
| Rheovis HS 1169 | Thickener | 0 | 0 | 0 | 0 | 0.1 | 0.2 | 0.3 | 0.4 | 0.8 | 1.2 |
| Total (percent) | | 100 | 100 | 100 | 100 | 100 | 100 | 100 | 100 | 100 | 100 |
| Dynamic viscosity (Pa · s)* | | <0.3 | <0.3 | <0.3 | 0.064 | 0.127 | 0.187 | 0.435 | 0.648 | 2.337 | 5.389 |

*determined according to the viscosity protocol at 20° C. and a 100 [symbol] shear rate [symbol]
indicates data missing or illegible when filed

Pressurized can

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | Ex. 10 |
| Aqueous polymer | see table above | 463 | 463 | 463 | 463 | 463 | 463 | 463 | 463 | 463 | 463 |
| composition | | | | | | | | | | | |
| Isobutane | Propellant | 19.2 | 19.2 | 19.2 | 19.2 | 19.2 | 19.2 | 19.2 | 19.2 | 19.2 | 19.2 |
| Propane | Propellant | 8.3 | 8.3 | 8.3 | 8.3 | 8.3 | 8.3 | 8.3 | 8.3 | 8.3 | 8.3 |
| Total grams | | 490.5 | 490.5 | 490.5 | 490.5 | 490.5 | 490.5 | 490.5 | 490.5 | 490.5 | 490.5 |
| Total milliliters | | 500 | 500 | 500 | 500 | 500 | 500 | 500 | 500 | 500 | 500 |

Results

| | | | | | GUN C (Spring | |
|---|---|---|---|---|---|---|
| | Gun A (Spring | | | | constant 3.72 | |
| | constant 0.0407 | | | | N/mm) | |
| | N/mm) | | GUN B (springless) | | (comp.) | |
| | | Joint | | Joint | | Joint |
| | Wt. % | yield (# | Wt. % | yield (# | Wt. % | yield (# |
| Formulation | can | of | can | of | can | of |
| of Example | residue | joints) | residue | joints) | residue | joints) |
| 1 | 9.18 | — | 12.0 | — | 21.33 | — |
| 6 | 9.24 | 20 | — | — | 17.09 | 14 |
| 9 (comp.) | 27.1 | 14.5 | — | — | — | — |

As can be seen from the results, the assemblies of the present invention provide both improved can yield (determined by the amount of residue left in the can) as well as improved joint yield (i.e. actual volume of product dispensed before post-expansion) compared to using a aqueous polymer composition which does not comply with the viscosity characteristic of the invention, or compared to using a dispensing gun which does not comply with the spring constant characteristic of the invention.

The formulation of example 1 dispensed with gun A was found to have an initial thermal conductivity (EN12667) of 0.03256 W/m*K and a dimensional stability (EN 17333-2 (2020) of −4.5%.

As can be seen from the information provided above, examples 1-10 all comprise about 5.6 wt. % propellant (by combined weight of foamable aqueous polymer composition and propellant). The present inventors have also tested the foamable aqueous polymer composition of example 7 employing about 2 wt. % propellant (by combined weight of foamable aqueous polymer composition and propellant), using the same isobutane:propane ratio. It was found that the hardness and the dimensional stability (tested according to EN 17333-2 (2020)) was further significantly improved compared to example 7.

1. An assembly for dispensing a polymeric foam comprising
a pressurized can comprising a foamable aqueous polymer composition and one or more propellants; and
a dispensing gun comprising a basket for fluidly connecting the can to the dispensing gun, said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked;
wherein the foamable aqueous polymer composition has a dynamic viscosity determined according to the viscosity protocol at 20° C. and a 100 s-1 shear rate of less than 1.5 Pa·s,
wherein the can has an internal relative pressure at 20° C. of at least 200 kPa, and
wherein the blocking means comprised in the basket permits flow from the pressurized can until an internal relative pressure at 20° C. of less than 120 kPa.

2. The assembly of claim 1 wherein the blocking means is a spring-loaded check valve comprising a spring having a spring constant of less than 1 N/mm,
or
wherein the basket comprises an elongated flow channel connecting the can to the dispensing gun and is equipped with a blocking means which comprises a pin-like structure placed inside the flow channel which is configured to be axially moveable in the flow channel between an open position wherein flow from the can to the dispensing gun is enabled and a closed position wherein flow from the can to the dispensing gun through the flow channel is blocked.

3. The assembly of claim 1, wherein the foamable aqueous polymer composition comprises 20-80 wt. % of polymer by total weight of the aqueous polymer composition and 20-70 wt. % water by total weight of the aqueous polymer composition.

4. The assembly according to claim 1, wherein the foamable aqueous polymer composition has a dynamic viscosity determined according to the viscosity protocol at 20° C. and a 100 s-1 shear rate of less than 1.2 Pa·s.

5. The assembly according to claim 1, wherein the foamable aqueous polymer composition has a dynamic viscosity determined according to the viscosity protocol at 20° C. and a 100 s-1 shear rate of at least 0.5 Pa·s.

6. The assembly according to claim 1, wherein the can has an internal relative pressure at 20° C. of at least 300 kPa.

7. The assembly according to claim 1, wherein the spring-loaded check valve is a ball-spring check valve.

8. The assembly according to claim 1, wherein the foamable aqueous polymer composition is substantially free of reactive isocyanate groups.

9. The assembly according to claim 1, wherein the foamable aqueous polymer composition comprises less than 5 wt. % by total weight of the foamable aqueous polymer composition of a monomer.

10. The assembly according to claim 1, wherein the ratio (w/w) of the foamable aqueous polymer composition to the one or more propellants is within the range of 70:30 to 99.5:0.5.

11. The assembly according to claim 1, wherein the foamable aqueous polymer composition has a minimum film forming temperature of less than 25° C.

12. The assembly according to claim 1, wherein the foamable aqueous polymer composition comprises a polymer selected from the group consisting of polyurethanes, polyacrylates, polyalkyl acrylates, polyurethane acrylate copolymers, polystyrenes, styrene acrylate copolymers, polyisocyanurates, polyvinylacetates, vinyl acetate alkylene copolymers, styrene alkyldiene copolymers, copolymers thereof, and combinations thereof, preferably a polymer selected from the group consisting of polyurethanes, polyacrylates, polyurethane acrylate copolymers, copolymers thereof, and combinations thereof.

13. The assembly of claim 12, wherein the foamable aqueous polymer composition comprises a polyurethane or a copolymer thereof.

14. The assembly according to claim 1, wherein the foamable aqueous polymer composition further comprises one or more additives selected from the group consisting of film forming agents, dispersing agents, pH adjusters, fillers, fire retardants, surfactants, thickeners, crosslinkers, adhesion promotors.

15. The assembly according to claim 1, wherein the one or more propellants are selected from the group consisting of dimethylether, hydrohaloolefins (preferably HFO 1234ze (E)), n-butane, isobutane, propane and combinations thereof.

16. The assembly according to claim 1, wherein the dispensing gun further comprises a dispensing tube with a dosing nozzle, means for opening and closing the dosing nozzle, and a trigger for actuating said means in order to open the dosing nozzle and to dispense the polymeric foam.

17. The assembly of claim 16, wherein the means for opening and closing the dosing nozzle comprise a spring-loaded needle which is co-axially moveable in the dispensing tube, and optionally further comprising regulating means for regulating the degree of opening of the outlet of the dosing nozzle.

18. A method of dispensing a polymeric foam comprising the steps of:
(i) providing a pressurized can comprising a foamable aqueous polymer composition and one or more propellants, wherein the foamable aqueous polymer composition has a dynamic viscosity determined according to the viscosity protocol at 20° C. and a 100 s-1 shear rate of less than 1.5 Pa·s, and wherein the can has an internal relative pressure at 20° C. of at least 200 kPa;
(ii) providing a dispensing gun comprising a basket for fluidly connecting the can to the dispensing gun, said basket comprising a flow channel connecting the can to the dispensing gun and a blocking means configured to be moveable between an open position wherein flow from the can to the dispensing gun is enabled and a closed position wherein flow from the can to the dispensing gun through the flow channel is blocked, wherein the blocking means comprised in the basket permits flow from the pressurized can until an internal relative pressure at 20° C. or less than 120 kPa;
(iii) mounting the pressurized can on the dispensing gun by fluidly connecting the can to the dispensing gun; and
(iv) dispensing the polymer composition from the can, thereby obtaining the polymeric foam.

19. The method of claim 18 wherein step (iv) is performed at an ambient temperature of at least 0° C.

20. The method of claim 18, wherein the polymeric foam obtained in step (iv) is a polyurethane foam having one or more of the following properties:
a post-expansion of at least 15% determined according to method EN 17333-2 (2020);
a dimensional change smaller than 10% determined according to method EN 17333-2 (2020);
a change in tensile strength of less than 10% after 1000 cycles of 10% compression and stretching according to method EN 17333-4 (2020), and/or
a thermal conductivity of less than 0.05 W/m*K determined according to DIN EN12667:2001.

21. The method of claim 18 which is for providing airtight sealing.

22. The method of claim 21 wherein the polymeric foam is deposited (a) around a door frame, such as an interior door frame of a building, or (b) between adjacent parts or layers of drywall.

23. The method of claim 18, wherein less than 15 wt. % residue is left in the can after maximally dispensing the polymer composition from the can, wherein 100 wt. % residue corresponds to the total amount of foamable aqueous polymer composition and propellants in the can before dispensing any polymer composition from the can.

24. (canceled)
